(19) United States
(12) Patent Application Publication
(10) Pub. No.: US 2025/0383723 A1
(43) Pub. Date: Dec. 18, 2025

(54) OPTICAL SYSTEM FOR A POSITION DETERMINATION DEVICE

(71) Applicant: FRESHAPE SA, Renens (CH)

(72) Inventors: Dmitrii UNUCHEK, Villaz-St-Pierre (CH); Nicola CUCCATO, Villaz-St-Pierre (CH); Thomas MALCOM, Villaz-St-Pierre (CH)

(21) Appl. No.: 18/878,374

(22) PCT Filed: Jun. 8, 2023
(86) PCT No.: PCT/IB2023/055932

§ 371 Date: Dec. 23, 2024

(30) Foreign Application Priority Data
Jul. 1, 2022 (EP) 22182646.4

(51) Int. Cl. G06F 3/03; G06F 3/0354

(52) U.S. Cl. CPC G06F 3/0321; G06F 3/03542; G06F 3/03545

(57) ABSTRACT

The present invention relates to an optical system (30) for a position determination device (20), in particular an optical stylus, for determination of the position of the device (20) relative to a position-encoded surface (50) having different position-encoded patterns (52). The optical system (30) comprises an image sensor (31) for capturing at least one image of any position-encoded pattern (52) of the position-encoded surface (50), one or more light sources (42) for illuminating any of the position-encoded patterns, a stop aperture (48), an object lens (32) with a side positioned away from the stop aperture by a first distance (d1) and an image lens (34) with a side positioned away from the stop aperture (48) by a second distance (d2). The optical system (30) further comprises a dynamic optical element (36) configured to be electrically actuated in order to form onto the image sensor (31) in-focus images of any position-encoded pattern (52) of the position-encoded surface (50) within working distances (WD) of the position determination device (20) comprising the optical system (30). The invention also concerns a method for determining a working distance of an optical stylus as a function of the 3D pose of the optical stylus relative to a position-encoded surface as well as a method for controlling the voltage to be applied on the dynamic optical element of the optical stylus.

### FIELD OF THE INVENTION

The present invention relates to an optical system for a position determination device such as an optical stylus for determining the position of the device relative to a position-encoded surface. The invention also relates to a method for determining a working distance of the position determination device relative to the position-encoded surface. The invention further relates to a method for controlling the voltage to be applied on a dynamic optical element of the position determination device as a function of the working distance of the device relative to the position-encoded surface.

### DESCRIPTION OF RELATED ART

Among user input devices, touch-sensitive displays provide the most natural way for human-computer interaction through simple gestures, signs or even hand-written text. In general, the use of a finger as an input device results in an imprecise outcome. Styli as position determination devices are widely used for more accurate data input.

However, independently of the technology used, most of the existing stylus have various limitations and require either physical contact or a very small separation between a pen and a screen. The scope of their applications therefore remains limited to rough graphical input within a two-dimensional plane.

A versatile optical stylus for 2D and 3D applications using an alternative approach to determine the object distance is disclosed in WO2022064412. The optical stylus described in this document is designed for a position determination device comprising a position-encoded surface having different position-encoded patterns. The optical stylus comprises an image sensor for capturing images of any position-encoded pattern of the position-encoded surface, and an optical arrangement comprising a dynamic optical element configured to be electrically actuated in order to adjust the focal length of the optical stylus as a function of a separation distance between a reference point of the optical stylus and the position of any position-encoded pattern to have a substantially in-focus position-encoded pattern corresponding to the position of the optical stylus.

The use of telecentric system comprising an object lens and an image lens arranged on both sides and at focal distance from a stop aperture is known in machine vision application where parallax errors should be limited. Telecentric systems advantageously provides constant magnification for objects independently of the distance between the objects and the object lens. These systems have however a limited depth of field where objects form sharp in-focus images.

This issue can be solved by decreasing the diameter of the stop aperture in order to increase the depth of field at the expense of light collection capabilities thereby retrieving images with low illumination leading to lower contrast and higher noise levels. In addition, decreasing the diameter of the stop aperture introduces diffraction effects which limit the maximum achievable resolution of optical systems.

Optical systems consisting of a dynamic optical element have the advantage to increase the depth of field over conventional telecentric systems. However, the dynamical optical element shows poor performances at controlling magnification variation at different focal length unlike the conventional telecentric systems.

An aim of the present invention is therefore to propose an optical system with a dynamic optical element, for a position determination device, in particular an optical stylus, which can be focused on close and far objects while magnification remains within a control magnification range for close and far objects when the position determination device operates in a predefined range of working distances.

Another aim of the present invention is to propose a method for determining a working distance of a position determination device, in particular an optical stylus, relative to a position-encoded surface.

A further aim of the present invention is to propose a method for controlling the voltage to be applied on a dynamic optical element of a position determination device, in particular an optical stylus, as a function of the working distance of the device relative to the position-encoded surface.

### BRIEF DESCRIPTION OF THE INVENTION

These aims are achieved notably by an optical system for a position determination device, in particular an optical stylus, for determination of the position of said device relative to a position-encoded surface having different position-encoded patterns. The optical system comprises an image sensor for capturing at least one image of any position-encoded pattern of the position-encoded surface, one or more light sources for illuminating any of said position-encoded patterns, a stop aperture, an object lens with a side positioned away from the stop aperture by a first distance and an image lens with a side positioned away from the stop aperture by a second distance. The optical system further comprises a dynamic optical element positioned in contact with the stop aperture or within a distance of 5 mm away from the stop aperture along the optical axis of the optical system. The dynamic optical element is configured to be electrically actuated in order to form onto the image sensor in-focus images of any position-encoded pattern of the position-encoded surface within working distances of the position determination device comprising said optical system.

In an embodiment, the range of said working distances has a minimum value of 10 mm and a maximum value of 100 mm.

In an embodiment, the ratio of magnification of the optical system between in-focus image formed or projected onto the image sensor, when the position determination device is at the minimum and maximum values of the range working distances, is below 3.

In an embodiment, the first distance is within a range from 0.5 to 1.2 of the focal length of the object lens.

In an embodiment, the optical system is a double telecentric system, wherein the first distance is equal to the focal distance of the object lens whereas the second distance is equal to the focal distance of the image lens.

In an embodiment, the optical system is of the type of an object-space telecentric system, wherein the first distance is equal to the focal lens of the object lens.

In an embodiment, the first distance is shorter than the focal length of the object lens while the second distance is shorter than the focal length of the image lens.

In an embodiment, the first distance is at least one and a half times shorter than the focal length of the object lens while the second distance is at least two times shorter than the focal length of the image lens.

In an embodiment, the optical system further comprises a circuit board. The dynamic optical element is an electrotuneable lens, for example liquid or polymer lens, which is mounted on a side of the circuit board. The circuit board comprises the stop aperture.

In an embodiment, the optical system further comprises a distance measurement sensor, for example an optical time-of-flight sensor, mounted between the dynamic optical element and the object lens.

In an embodiment, the optical system further comprises an optical filter arranged to allow the passage of the light emitted by the light sources to reach the image sensor and to prevent the light emitted by the distance measurement sensor from reaching the image sensor or at least attenuate this light before reaching the image sensor.

In an embodiment, the optical filter is in the form of a coating coated on the image lens.

In an embodiment, the one or more light sources is/are arranged such that the central axis of the light cone emitted by the or each light source intersects the optical axis of the object lens for optimal illumination intensity.

Another aspect of the invention relates to an optical stylus comprising the optical system.

In an embodiment, the one or more light sources is/are mounted between the dynamic optical element and a distal end of the optical stylus, preferably between the dynamic optical element and the object lens.

In an embodiment, the optical stylus further comprises an ink chamber.

Another aspect of the invention relates to a method for determining a working distance of an optical stylus as a function of the 3D pose of the optical stylus relative to a position-encoded surface comprising position-encoded patterns. The optical stylus comprises an image sensor for capturing at least one image of any position-encoded pattern of the position-encoded surface; an object lens and an image lens arranged on both sides of a stop aperture; a dynamic optical element mounted between the object lens and the image lens and configured to be electrically actuated in order to form onto the image sensor in-focus images of any position-encoded pattern of the position-encoded surface within a range of working distances along the optical axis of the stylus; a distance measurement sensor, for example an optical Time-of-Flight sensor, for measuring said working distance; and a processing unit to control the dynamic optical element as a function of said working distance.

The processing unit corrects in real time the signal acquired by the distance measurement sensor as a function of the tilt angle and the roll angle of the 3D pose of the optical stylus relative to the position-encoded surface to compute the working distance.

In an embodiment, the tilt and roll angles of the 3D pose of the optical stylus relative to the position-encoded surface are obtained from an Inertial Measurement Unit—IMU, or from an algorithm based on the perspective distortion of the image of the position-encoded pattern as captured by the image sensor, or by using the data obtained by both the IMU and the algorithm.

In an embodiment, the working distance of the optical stylus is obtained by executing by the processing unit the following equation:

$$W D = ( {D}_{M} \cdot \frac{r}{\sqrt{{r}^{2} + {L}_{o}^{2}}} - r ) ( \frac{Lo}{r} + cos ψ \cdot tan φ )$$

wherein
D_{M} is the distance measured by the distance measurement sensor,
L_{O} is the distance between the distance measurement sensor and the outer surface of the object lens along the optical axis of the stylus,
r is the orthogonal distance between the optical axis of the stylus and the position of the distance measurement sensor, and
φ and ψ are respectively the tilt and the roll angles of the optical stylus.

In an embodiment, the distance between the position-encoded surface and the distal end of the optical stylus, along an axis parallel to the optical axis, is obtained by executing by the processing unit the following equation:

$${D}^{tip} = ( {D}_{M} \cdot \frac{r}{\sqrt{{r}^{2} + {L}_{o}^{2}}} - r ) ( \frac{{L}_{0}}{r} + cos ψ \cdot tan φ ) - {L}_{tip} + R \cdot cos ψ \cdot tan φ$$

wherein
D_{M} is the distance measured by the distance measurement sensor,
L_{O} is the distance between the distance measurement sensor and the object lens along the optical axis of the stylus,
r is the orthogonal distance between the optical axis of the stylus and the position of the distance measurement sensor,
φ and ψ are respectively the tilt and the roll angles of the optical stylus,
Lₜᵢₚ is the distance between the outer surface of the object lens and the distant end of the optical stylus along the optical axis of the stylus, and
R is the orthogonal distance between the optical axis O and the axis of the rod of the stylus.

In an embodiment, the closest distance between the position-encoded surface and the distal end of the optical stylus is obtained by executing by the processing unit the following equation:

$${D}_{N}^{tip} = {D}^{tip} \cdot cos φ$$

Another aspect of the invention relates to a method for controlling the voltage to be applied on a dynamic optical element of an optical stylus as a function of the 3D pose of the optical stylus relative to a position-encoded surface comprising different position-encoded patterns. The optical stylus comprises: an image sensor for capturing at least one image of any position-encoded pattern of the position-encoded surface; a dynamic optical element configured to be electrically actuated in order to form onto the image sensor in-focus images of any position-encoded pattern of the position-encoded surface within a range of working distances of the optical stylus; a distance measurement sensor for measuring said working distance, and a processing unit to control the dynamic optical element as a function of said working distance.

The method comprises the steps of: a. performing a measurement of said working distance with the distance measurement sensor, and b. determining the electrical voltage to be applied on the dynamic optical element by means of a distance-to-voltage conversion model using either an analytical model describing the relation between the voltage to be applied and the measurement distance of said working distance, or a look-up table storing the value of the voltage to be applied for any measurement of said working distance.

In an embodiment, the step a. of the method is followed by the additional steps of: c. obtaining at least one measurement performed by another sensor, such as the image sensor or an IMU sensor, including in the optical stylus, and d. running on the processing unit a sensor fusion algorithm, such as a Kalman filter, to obtain a more precise measurement of said working distance as a function of the data obtained by the distance measurement sensor and said another sensor.

In an embodiment, the method comprises the additional steps of:
determining by an image analysis algorithm whether the quality of one or more images acquired by the image sensor is/are above a given threshold to ensure that the image of the position-encoded pattern is good enough to be used by the optical stylus, and
adapting the distance-to-voltage conversion model when the quality is below said given threshold to modify the focal length of the dynamic optical element so as to restore the quality of said one or more images above said given threshold.

### BRIEF DESCRIPTION OF THE DRAWINGS

The invention will be better understood with the aid of the description of several embodiments given by way of examples and illustrated by the figures, in which:

FIG. 1a is a perspective view of an optical module of the optical system according to an embodiment;

FIG. 1b shows a cross-sectional perspective view of a part of an optical stylus comprising an optical system according to an embodiment;

FIG. 1c shows a side view of FIG. 1b;

FIG. 2a shows a cross-sectional perspective view of a part of an optical stylus comprising an optical system according to another embodiment,

FIG. 2b shows a side view of FIG. 2a,

FIGS. 3a and 3b are schematic explanation views of the optical system, wherein opposite sides of the image lens comprise a coating with respectively an optical filter and an antireflective filter while the variable-focal-length lens and the object lens comprise each an antireflective coating according to an embodiment.

FIG. 4 shows a schematic view of an optical system of the type of a double telecentric system, comprising a lens with a variable focal length according to an embodiment;

FIG. 5 shows a schematic view of an optical system of the type of an object-space telecentric system, comprising a lens with a variable focal length according to another embodiment;

FIG. 6 shows a schematic view of a compact optical system, according to another embodiment, comprising a lens with a variable focal length, and designed to focus on close and far objects while magnification remains within a control magnification ratio;

FIG. 7 shows a schematic view of an optical system, according to another embodiment, whose optical axis is perpendicular to the surface of the position encoded surface and comprising both a distance measurement sensor and a light source arranged between the lens with a variable focal length and the object lens;

FIG. 7a shows a side view of an optical position determination device comprising a position-encoded surface and an optical stylus integrating the optical system of FIG. 7 and whose optical axis is perpendicular to the surface of the position-encoded surface;

FIG. 8 shows is a schematic view of an optical system, according to another embodiment, comprising a distance measurement sensor and a light source which are both arranged such that the central axis of the light cone emitted by both the distance measurement sensor and the light source intersect the optical axis of the system, and

FIGS. 9a to 9c shows different views of the part of the optical stylus of FIGS. 1b and 1c and different geometrical parameters for correction of the signal acquired by a distance measurement sensor as a function of the working distance of the optical stylus relative to the position-encoded surface.

### DETAILED DESCRIPTION OF SEVERAL EMBODIMENTS OF THE INVENTION

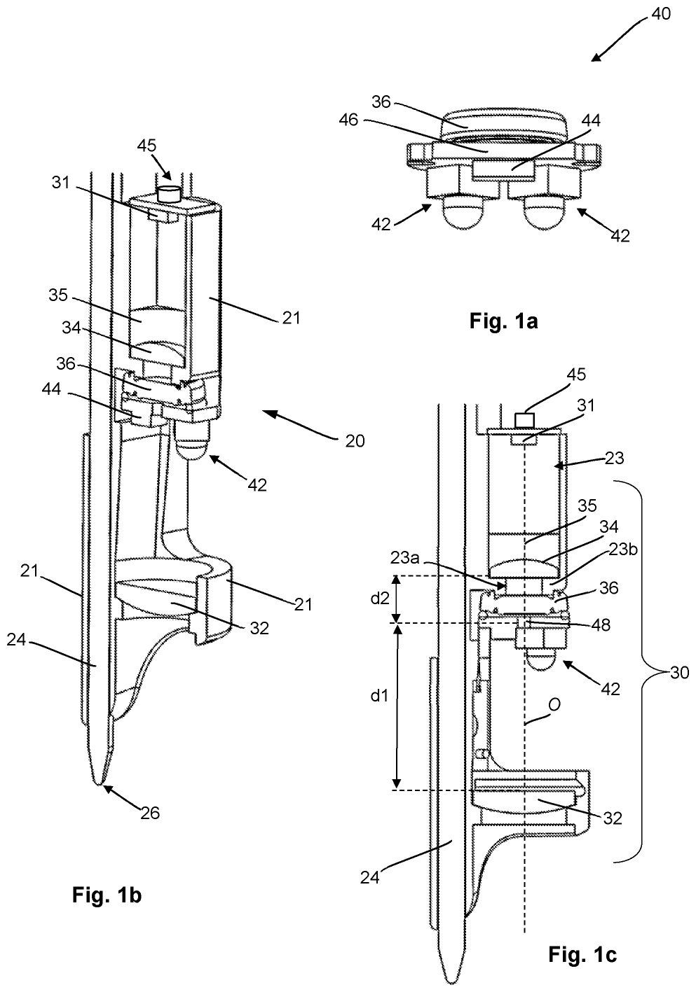

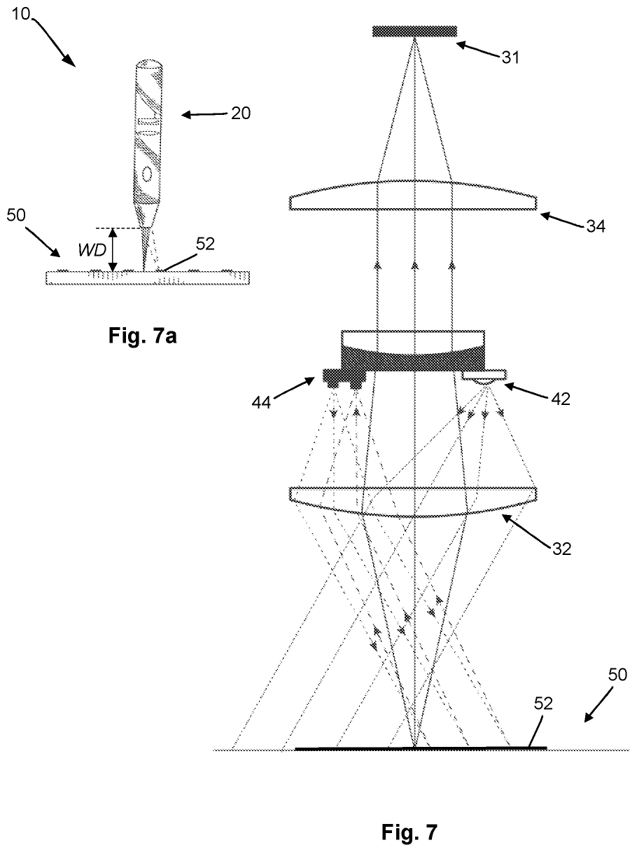

In a preferred embodiment, the position determination device is an optical stylus 20, as shown for example in FIGS. 1b and 1c. The optical stylus is configured to determine its 3D pose relative to a position-encoded surface 50 as shown in FIG. 7a and as described in detail in WO2022/064412, the content of which is hereby incorporated by reference. Within the context of the present invention, the term “3D pose” of the optical stylus 20 shall be understood as a combination of (1) a two-dimensional coordinates of a reference point of the optical stylus relative to the position-encoded surface such as its distal end or tip 26, (2) a distance between the reference point of the optical stylus and the position-encoded surface and (3) orientation of the optical stylus relative to the position-encoded surface, wherein the orientation may be expressed in Euler angles, in yaw, pitch and roll angles, in quaternions or in rotation matrices.

In the embodiment shown in FIGS. 1a to 1c, the optical stylus 20 comprises a rod 24 and a housing 21 accommodating the rod 24. In an embodiment, the rod 24 may comprise an ink chamber for writing or drawing on a piece of paper in a conventional way. The optical stylus 20 comprises an optical system 30 mounted in the stylus housing 21 next to the stylus rod 24. The optical system 30 comprises an image sensor 31, an object lens 32 arranged on a first side of a stop aperture 48 and an image lens 34 arranged in a second side of the stop aperture opposite the first side. The image sensor 31 and the image lens 34 are arranged on a sensor chamber 23 of the stylus housing 21. The image lens 34 is mounted on a front side of the chamber 23 while the image sensor 31 is mounted on a rear side of the chamber 23 for capturing images of any position-encoded pattern 52 of the position-encoded surface 50 as shown in FIG. 7a.

The image lens 34 is arranged against a shoulder 23b located on the front side of the sensor chamber 23. The optical system 30 further comprises an optical filter 35, as a stand-alone component, mounted against the image lens 34. The optical filter may be instead a lens coating as described below. The shoulder 23b surrounds a chamber opening 23a through which light can pass so as to travel through the image lens 34, the optical filter 35 and onto the image sensor 31. The function of the optical filter 35 will be described in detail subsequently.

The optical system 30 of the embodiment of FIGS. 1a-1c further comprises an optical module 40 mounted between the object lens 32 and the image lens 34. The optical module 40 comprises a circuit board 46 having a first side facing the image lens 34 and a second side facing the object lens 32. A dynamic optical element 36 is mounted against the first side of the circuit board 46 while one or more light sources 42, for example LEDs, are mounted on the second side of the circuit board 46. The circuit board 36 further comprises the stop aperture 48 which is aligned with the optical axis O of the optical system 30. The stop aperture may however be separated from the circuit board according to a variant.

The dynamic optical element 36 is preferably an electrotuneable lens, for example liquid or polymer lens, which is either in direct contact with the stop aperture 48 or within a distance of 5 mm from the stop aperture.

The electrotuneable lens 36 is electrically connected to the circuit board 46 such that a voltage can be applied on electrotuneable lens 36 as a function of the working distance of the optical stylus 20 relative to a position-encoded surface 50 as described later. In the context of the present invention, the “working distance WD” of the optical stylus shall be understood as the distance, along the optical axis O of the optical system 30, between any position-encoded pattern 52 of the position-encoded surface 50, and the outer surface of the object lens 32 of the optical system.

Constant control of the voltage applied on the electrotuneable lens 36 ensures that any position-encoded pattern 52 is sharp enough within the range of working distances WD of the optical stylus 20. The working distance WD may vary between 10 mm (when the distal end 26 of the stylus is in contact with the position encoded surface), and 100 mm, preferably between 15 mm and 65 mm.

In the embodiment shown in FIGS. 1a to 1c, the optical module 40 comprises several LEDs 42 connected to the second side of the circuit board 46, for example three LEDs angularly offset from each other by approximately 120° around the stop aperture 48. The optical module 40 also comprises a distance measurement sensor, preferably an optical Time-of-Flight sensor 44 connected to the second side of the circuit board 46.

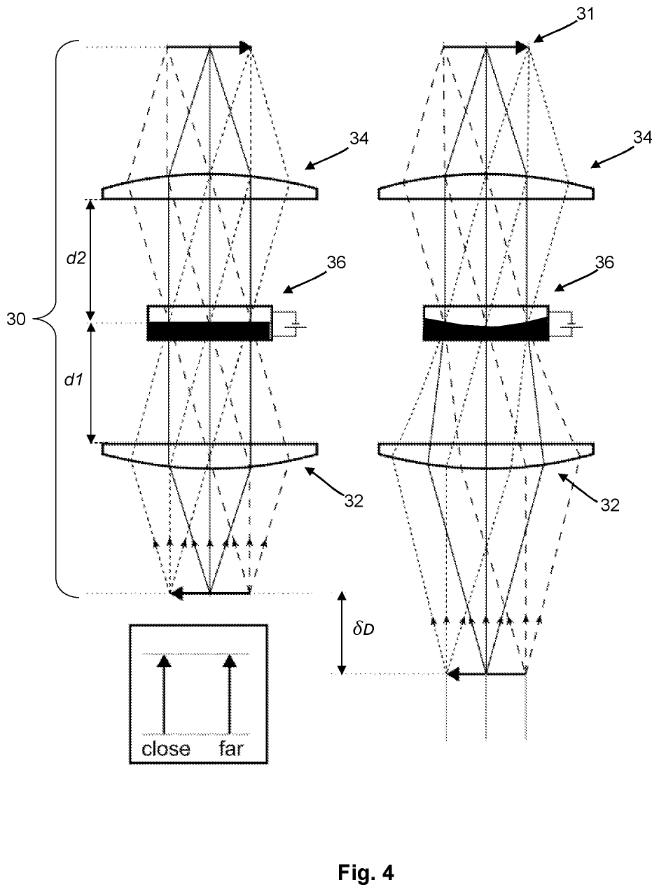

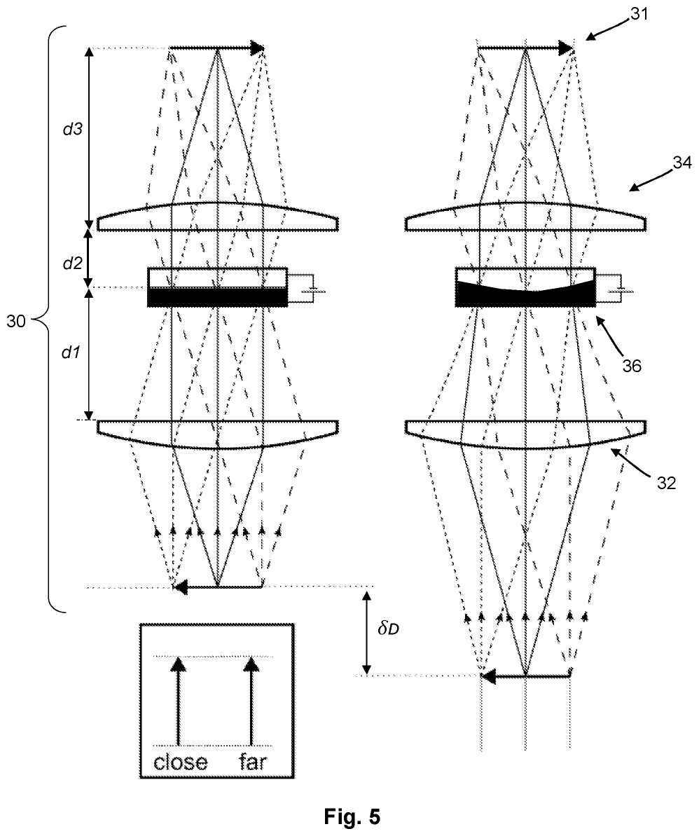

With reference to FIG. 1c, a side of the object lens 32 of the optical system 30 is positioned away from the stop aperture 38 by a first distance d1, whereas a side of the image lens 34 is positioned away from the stop aperture by a second distance d2. The ratio between the first and second distances d1, d2 may vary according to the type of the optical system described below with references to FIGS. 4 to 6.

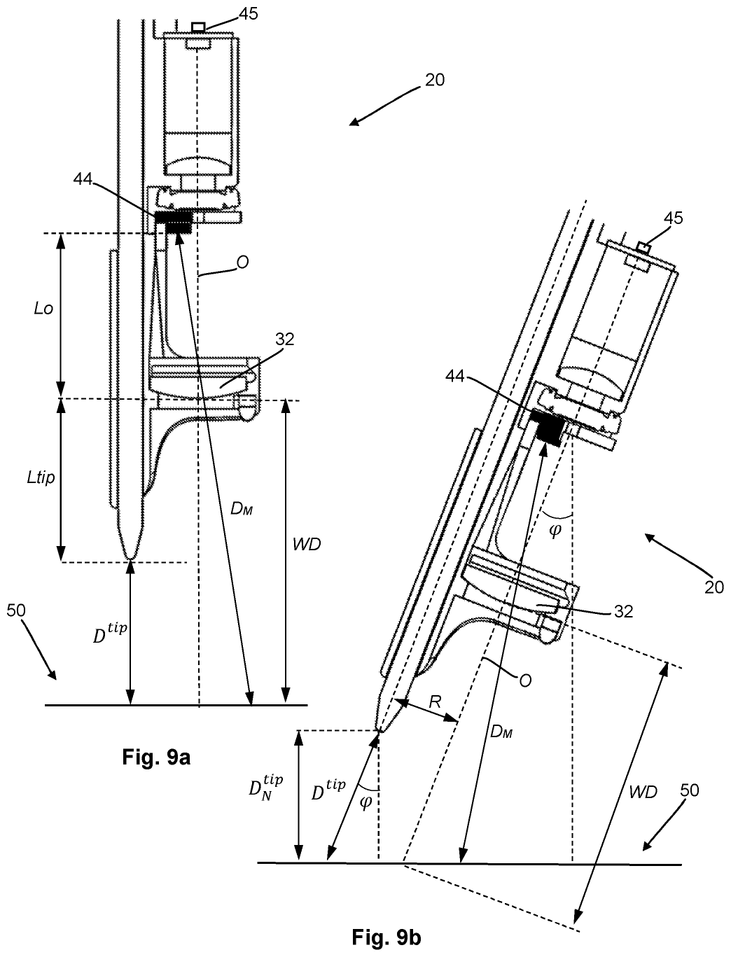

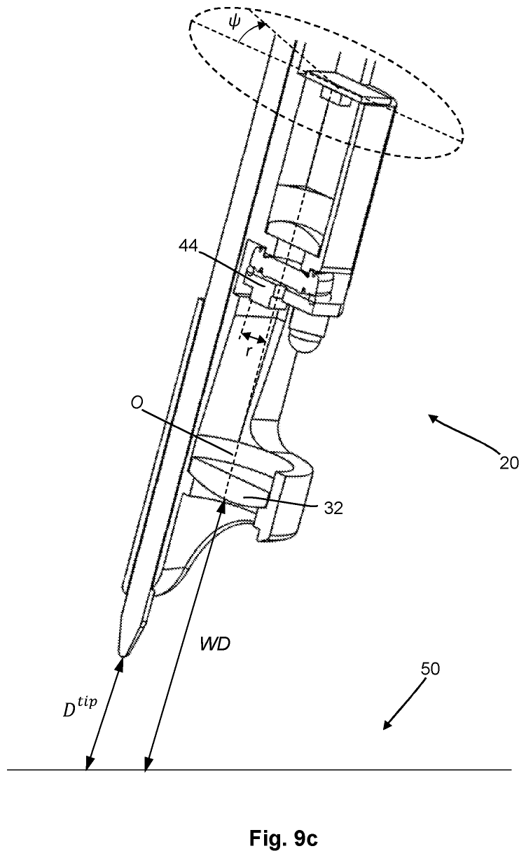

In an embodiment, the optical stylus 20 also comprises an Inertial Measurement Unit (IMU) 35 for measuring the tilt angle φ and the roll angle ψ of the optical stylus (FIGS. 9a to 9c).

In another embodiment, the tilt angle φ and the roll angle ψ of the optical stylus are computed by a positioning algorithm based on image analyses of the captured position-encoded pattern 52. In a further embodiment, the tilt angle φ and the roll angle ψ of the optical stylus are obtained by fusing the data measured by the IMU 35 with those acquired by the positioning algorithm in order to obtain more robust values for these angles.

The optical module 30 and the IMU are both in communication with a processing unit (not shown) of the optical stylus 20 in order to control the voltage to be applied on the electrotuneable lens 36 as a function of the output of the distance measurement sensor 44 as discussed thereafter in order to control the focal length of the electrotuneable lens 36 to ensure that the image of any position-encoded pattern 52 acquired by the image sensor 31 is sharp enough to be decoded by an image recognition algorithm. The image recognition algorithm may also be adapted to control in real-time the quality of the images acquired by the image sensor 31 so as to control the voltage to be applied electrotuneable lens 36 when the quality of these images is too poor to be decoded.

Position-encoded patterns 52 may be for example in form of tags encoding the X-Y two-dimensional coordinate grid or in the form of different patterns which can be decoded back to the coordinates of particular position on the position-encoded surface 50. As an alternative, position-encoded patterns 52 may be in form of unique tags or signs which can be univocally assigned to a particular position on the position-encoded surface 50. A look-up table comprising a series of corresponding unique tags or sign, and data relative to the position of each unique pattern or sign of the encoded surface, may be stored in a memory which may be integrated into the stylus housing 21 of the optical stylus or in a host device in communication with the optical stylus to receive unprocessed optical signal from the optical stylus corresponding to a unique tag or sign.

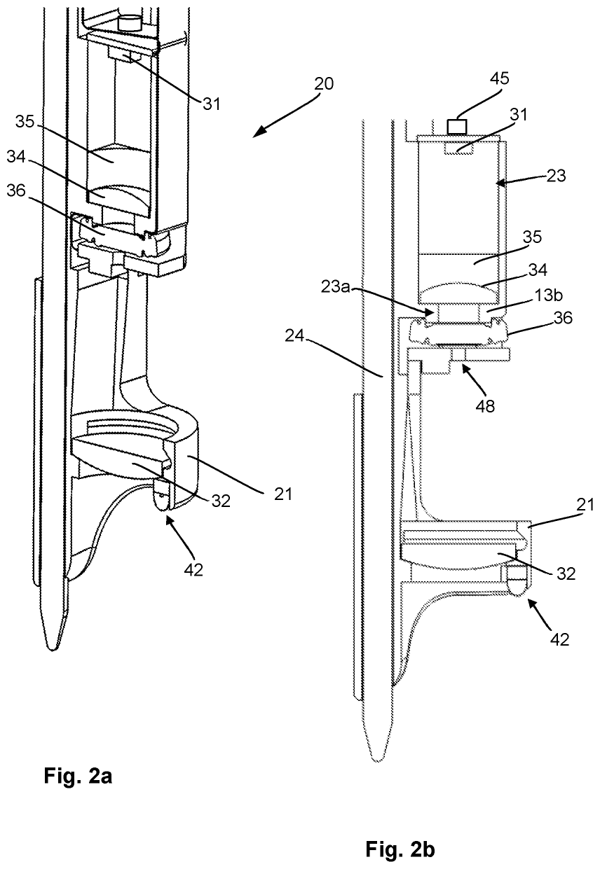

In the illustrated embodiment of FIGS. 2a, 2b, the optical stylus 20 is similar to the optical stylus of FIGS. 1b-1c, the only difference being the integration of the light sources at the level of the object lens 32. More particularly, several LEDs 42 are integrated in the stylus housing 21 surrounding the object lens 32, for example three LEDs offset from each other by approximately 120°.

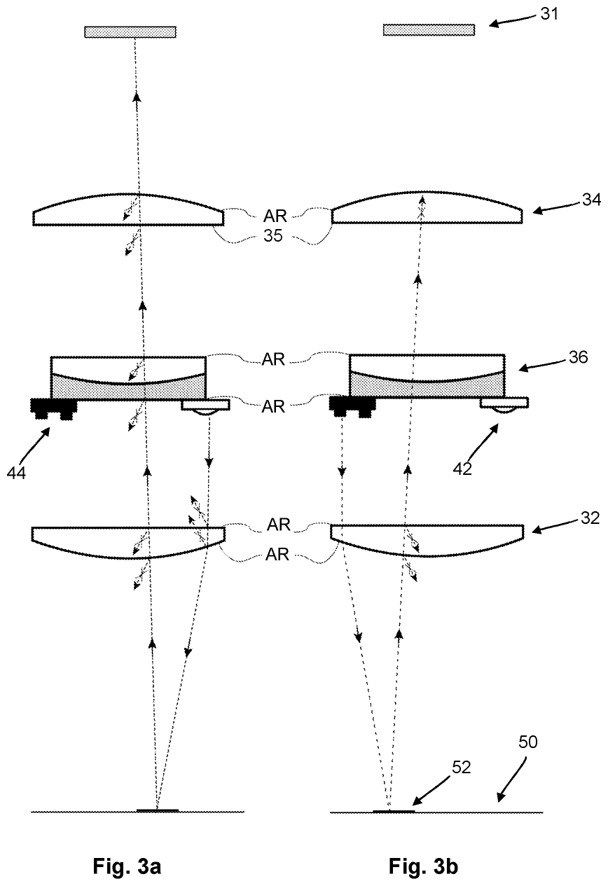

With reference to FIGS. 3a and 3b, LEDs 42 emitting light invisible to the human eye are preferably chosen such as NIR LEDs with a wavelength ranging from 800 to 900 nm, preferably around 850 nm. The emitter of the optical Time-of-Flight sensor 44 generally sends photons at longer wavelengths exceeding 900 nm, preferably around 940 nm. With reference to FIG. 3a, the light source emits light which passes through the object lens 32 into the position-encoded patterns 52 of the position-encoded surface 50. The light is then reflected/scattered on the surface 50 and sent back through the object lens 32, and passes through the electrotuneable lens 36, the image lens 34 and onto the image sensor 31 which acquired the image of the position-encoded patterns 52.

In an embodiment, The object lens 32 and the electrotuneable lens 26 comprise each at least one antireflective coating AR to minimize reflections and improve transmission of light through these optical components for optimal contrast ratio of the image captured.

Referring now to FIG. 3b, the photons sent by the Time-of-Flight sensor 44 pass through the object lens 32 onto the position-encoded patterns 52 of the position-encoded surface 50. The photons are then reflected/scattered on the surface 50 and sent back through the object lens 32, and a part of the photons are received by Time-of-Flight sensor 44 to measure the working distance WD as shown in FIGS. 10a-10c. Another part of the photons passes through the electrotuneable lens 36. These photons should however not reach the image sensor as they would degrade the quality of the acquired image which may prevent decoding of the position-encoded pattern.

Accordingly, the image lens 34 comprises a coating integrating an optical filter 35 adapted to prevent the photons emitted by the Time-of-Flight sensor 44 from reaching the image sensor 31 while allowing the passage of the light emitted by the LEDs 42 so that the image sensor can capture the image of the position-encoded pattern 52. The optical filter 35 may be a band pass filter, a short pass filter or combination of different filters.

FIGS. 4 to 6 show schematically different arrangement of the optical system 30 according to different embodiments.

In the embodiment of FIG. 4, the optical system 30 is of the type of a double telecentric system comprising the dynamic optical element 36 at the level of the stop aperture (not shown). Accordingly, the first distance d1 between the object lens 32 and the stop aperture is equal to the focal distance of the object lens while the second distance d2 between the image lens 22 and the stop aperture is equal to the focal distance of the image lens. The optical system 30 according to this embodiment ensure the acquisition by the image sensor 31 of in-focus images of any position-encoded pattern 52 within a shift δD in the working distance WD by controlling in real-time the voltage applied on the electrotuneable lens 36 as a function of the shift δD thereby resulting in different optical powers of the electrotuneable lens 36.

As a result, the magnification of any position-encoded pattern 52 captured by the image sensor 31 remains constant within the shift δD in the working distance WD.

In the embodiment of FIG. 5, the optical system 30 is of the type of an object-space telecentric system comprising the dynamic optical element 36 at the level of the stop aperture (not shown). The first distance d1 between the object lens 32 and the stop aperture is therefore equal to the focal distance of the object lens while the second distance d2 between the image lens 34 and the stop aperture is smaller, for example two times smaller, than the focal length of the image lens 34.

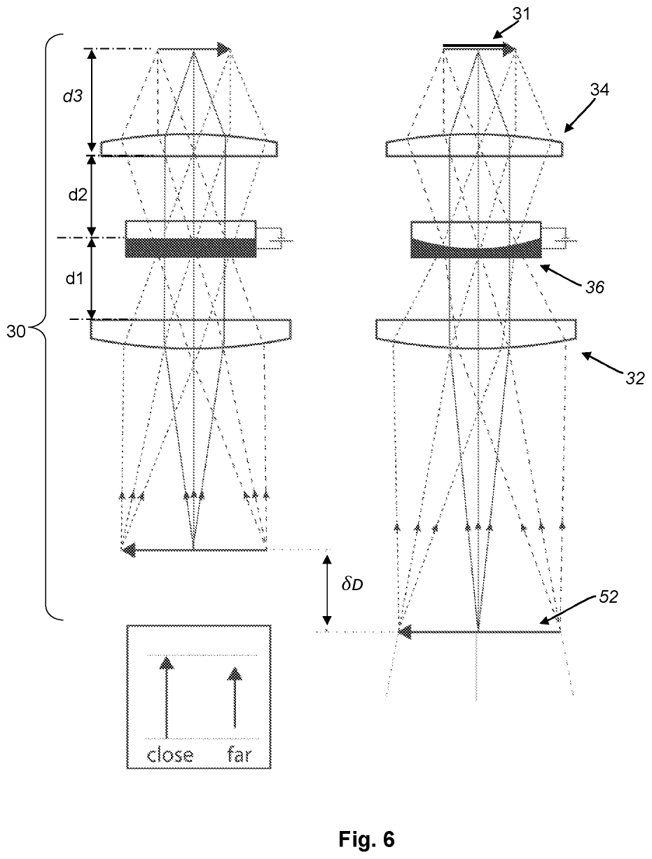

In the embodiment of FIG. 6, the optical system 30 is a non-telecentric system comprising the dynamic optical element 36 at the level of the stop aperture (not shown). The first distance d1 between the object lens 32 and the stop aperture is at least one and a half times shorter than the focal length of the object lens 32 while the second distance d2 between the image lens 34 and the stop aperture is at least two times shorter than the focal length of the image lens. The optical system 30 according to this embodiment allows a limited relative change of the optical magnification of any position-encoded pattern within the shift δD in the working distance. This relative change remains under control and is for example less than 50% and preferably less than 30%. Minor variations of the optical magnification may advantageously be used for extracting information on the working distance WD of the optical stylus without affecting the readability of the position-encoded pattern.

In this embodiment, the distance d3 between the image lens 34 and the image sensor 31 is within a range from 0.8 to 1.2 of the focal length of the object lens 32.

FIG. 7 shows the optical system 30 according to an embodiment, whereby the distance measurement sensor 44 and one or more light sources 42 are mounted between the electrotuneable lens 36 and the object lens 32. The optical system 30 is adapted to be integrated into an optical stylus 20 to be used with a position-encoded surface 50 as shown in FIG. 7a. The position-encoded surface 50 comprises multiple position-encoded patterns 52 in order to detect the 3D pose of the stylus 20 relative to the surface 50.

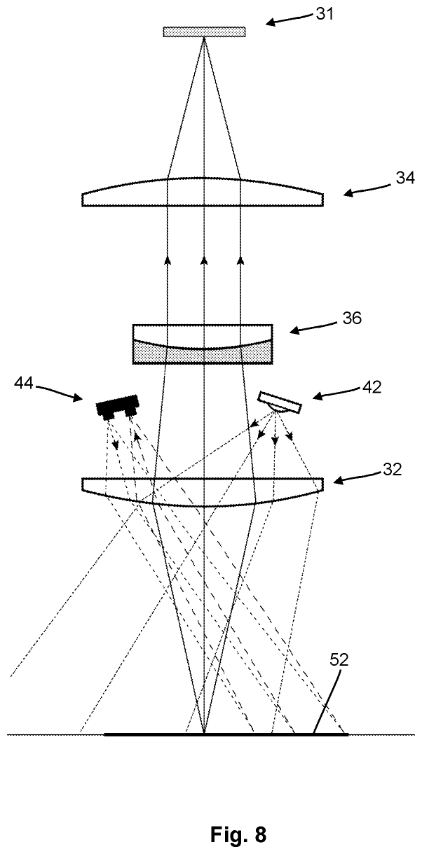

With reference to the embodiment of FIG. 8, one or more light sources 42 are arranged such that the central axis of the light cone emitted by each light source intersects the optical axis of the object lens 32 for optimal illumination intensity. The distance measurement sensor 44 may also be arranged such that the central axis of the light cone emitted by the sensor 44 intersects the optical axis of the object lens 32. This allows the sensor to receive more photons to increase the robustness of the measurement.

The voltage to be applied on electrotuneable lens 36 of the optical stylus 20 is determined as a function of the 3D pose of the optical stylus 20 relative the position-encoded surface 50 comprising the position-encoded patterns 52. The output of the distance measurement sensor 44 may directly be used for applications where a coarse measurement of working distance WD is good enough.

For applications requiring a precise measurement of the working distance WD on the other hand, the output of the distance measurement sensor 44 must be corrected to take into consideration the geometrical constraint as shown in FIGS. 9a to 9c.

The processing unit of the optical stylus, when in use, corrects in real-time the signal acquired by the distance measurement sensor 44 as a function of the tilt angle φ and the roll angle ψ of the 3D pose of the optical stylus 20 relative to the position-encoded surface 50 in order to compute the working distance WD. The tilt and roll angles φ, ψ are either measured in real-time by the IMU 35 of the optical stylus, or computed by a positioning algorithm based on the captured image of a position-encoded pattern or by fusing the data from the IMU and the dated computed by the positioning algorithm.

More particularly, the working distance WD is obtained by executing by the processing unit the following equation:

$$WD = ( {D}_{M} \cdot \frac{r}{\sqrt{{r}^{2} + {L}_{o}^{2}}} - r ) ( \frac{Lo}{r} + cos ψ \cdot tan φ )$$

wherein
D_{M} is the distance measured by the distance measurement sensor 44,
L_{O} is the distance between the distance measurement sensor and the outer surface of the object lens 32 along the optical axis O of the stylus,
r is the orthogonal distance between the optical axis O of the stylus and the position of the distance measurement sensor 44, and
φ and ψ are respectively the tilt and the roll angles of the optical stylus.

In order to determine the working distance WD of the optical stylus 20, the distance value acquired by the measurement sensor 44 is corrected by applying the geometric constraint as described above. The electrical voltage to be applied on the electrotuneable lens 36 is determined by means of a distance-to-voltage conversion model using the corrected distance.

In an embodiment, the conversion model uses an analytical model describing the relation between the voltage to be applied on the electrotuneable lens 36 and the working distance WD computed by the processing unit of the optical stylus based on the output of the distance measurement sensor.

In another embodiment, the conversion model uses a look-up table storing values of the voltage to be applied on the electrotuneable lens 36 for any value of the working distance WD computed by the processing unit of the stylus.

In an embodiment, determinisation of the working distance WD in an accurate manner is a multi-steps process, comprising the following steps:
performing a coarse measurement of the working distance WD with the distance measurement sensor 44;
obtaining at least one measurement performed by one or more sensors, such as the image sensor 31 and/or the IMU 45 of the optical stylus 20, and
running on the processing unit a sensor fusion algorithm, such as a Kalman filter, to obtain a more precise measurement of the working distance WD as a function of the data obtained by the distance measurement sensor 44, the image sensor 31, and/or the IMU 45 of the optical stylus.

The processing unit of the optical stylus may run an image analysis algorithm to determine whether the quality of one or more images acquired by the image sensor is/are above a given quality threshold to ensure that the image of the position-encoded pattern is good enough to be used by the optical stylus. The “quality” of the acquired images may be linked to the following metrics: contrast, sharpness, entropy, and signal-to-noise ratio.

The quality of the images acquired by the image sensor may indeed vary over time because electrotuneable lens tend to deteriorate in the long run which has a negative repercussion on the flexibility of the lens. The voltage to be applied on the electrotuneable lens to obtain a given focal length may therefore vary with time.

The distance-to-voltage conversion model must therefore be adapted when the quality of the image acquired by the image sensor is below the quality threshold to modify the focal length of electrotuneable lens 36 so as the restore the quality of the images above the quality threshold in order to overcome possible degradation of the electrotuneable lens.

In some digital applications, the distance D^{tip} between the position-encoded surface 50 and the distal end or the tip 26 of the optical stylus 20, along an axis parallel to the optical axis O, is required to know for example when the user brings the stylus in contact with the position-encoded surface. This distance is obtained by executing by the processing unit the following equation:

$${D}^{tip} = ( {D}_{M} \cdot \frac{r}{\sqrt{{r}^{2} + {L}_{o}^{2}}} - r ) ( \frac{{L}_{0}}{r} + cos ψ \cdot tan φ ) - {L}_{tip} + R \cdot cos ψ \cdot tan φ$$

wherein
D_{M} is the distance measured by the distance measurement sensor 44,
L_{O} is the distance between the distance measurement sensor and the outer surface of the object lens 32 along the optical axis O of the stylus,
r is the orthogonal distance between the optical axis O of the stylus and the position of the distance measurement sensor 44,
φ and ψ are respectively the tilt and the roll angles of the optical stylus,
Lₜᵢₚ is the distance between the outer surface of the object lens 32 and the tip of the stylus along the optical axis O of the stylus, and
R is the orthogonal distance between the optical axis O and the axis of the rod 24 of the stylus.

In other digital applications, the closest distance

$${D}_{N}^{tip}$$

from the distal end 26 of the optical stylus 20 may be required. For example, the Z-coordinate of the tip 26, which corresponds to the closest distance

$${D}_{N}^{tip} ,$$

is required for 3D design applications. This distance

$${D}_{N}^{tip}$$

may also be used to display the shadow following the movements of the optical stylus right under the tip. This distance is obtained by executing by the processing unit the following equation:

$${D}_{N}^{tip} = {D}^{tip} \cdot cos φ$$

The invention described above is not limited to an optical stylus. The optical system may indeed be integrated into any device used for position determination.

### REFERENCE LIST

Position determination device (e.g. optical stylus) 20
   Housing 21
   Sensor chamber 23
      Chamber opening 23a
      Shoulder 23b
   Rod 24
      Ink chamber 25
      Distal end 26
   Optical system 30
      Image sensor 31
      Object lens 32
         Antireflective coating AR
      Image lens 34
         Antireflective coating AR
      Optical filter 35
      Dynamic optical element 36
         Electrotuneable lens
         Antireflective coating AR
      Optical module 40
         Light sources 42
         e.g. LED
         Distance measurement sensor 44 (e.g. Time-of-flight sensor)
         IMU 45
         Circuit board 46
         Stop aperture 48
Position-encoded surface 50
   Position-encoded patterns 52
First distance d1
Second distance d2
Optical axis O
Working distance WD
Working distance shift δD
Tip distance D^{Tip}
Closest distance

$${D}_{N}^{Tip}$$

1. Optical system for a position determination device, in particular an optical stylus, for determination of the position of said device relative to a position-encoded surface having different position-encoded patterns, the optical system comprising an image sensor for capturing at least one image of any position-encoded pattern of the position-encoded surface, one or more light sources for illuminating any of said position-encoded patterns, a stop aperture, an object lens with a side positioned away from the stop aperture by a first distance and an image lens with a side positioned away from the stop aperture by a second distance, the optical system further comprising a dynamic optical element positioned in contact with the stop aperture or within a distance of 5 mm away from the stop aperture along the optical axis of the optical system, the dynamic optical element being configured to be electrically actuated in order to form onto the image sensor in-focus images of any position-encoded pattern of the position-encoded surface within working distances of the position determination device comprising said optical system.

2. The optical system according to claim 1, wherein the range of said working distances has a minimum value of 10 mm and a maximum value of 100 mm.

3. The optical system according to claim 2, wherein the ratio of magnification of the optical system between in-focus image form onto the image sensor, when the position determination device is at the minimum and maximum values of said range, is below 3.

4. The optical system according to claim 1, wherein the first distance is within a range from 0.5 to 1.2 of the focal length of the object lens.

5. The optical system according to claim 1, of the type of a double telecentric system, wherein said first distance is equal to the focal distance of the object lens whereas said second distance is equal to the focal distance of the image lens.

6. The optical system according to claim 1, of the type of an object-space telecentric system, wherein said first distance is equal to the focal lens of the object lens.

7. The optical system according to claim 1, wherein said first distance is shorter than the focal length of the object lens, and wherein said second distance is shorter than the focal length of the image lens.

8. The optical system according to claim 7, wherein said first distance is at least one and a half times shorter than the focal length of the object lens and wherein said second distance is at least two times shorter than the focal length of the image lens.

9. The optical system according to claim 1, further comprising a circuit board, wherein the dynamic optical element is an electrotuneable lens, for example liquid or polymer lens, which is mounted on a side of the circuit board, said circuit board comprising the stop aperture.

10. The optical system according to claim 1, further comprising a distance measurement sensor, for example an optical time-of-flight sensor, mounted between the dynamic optical element and the object lens.

11. The optical system according to claim 10, further comprising an optical filter arranged to allow the passage of the light emitted by the light sources to reach the image sensor and to prevent the light emitted by the distance measurement sensor from reaching the image sensor or at least attenuate said light before reaching the image sensor.

12. The optical system according to claim 1, wherein the one or more light sources is/are arranged such that the central axis of the light cone emitted by the or each light source intersects the optical axis of the object lens for optimal illumination intensity.

13. Optical stylus comprising the optical system according to claim 1.

14. The optical stylus according to claim 1, wherein said one or more light sources is/are mounted between the dynamic optical element and a distal end of the optical stylus, preferably between said dynamic optical element and the object lens.

15. Method for determining a working distance of an optical stylus as a function of the 3D pose of the optical stylus relative to a position-encoded surface comprising position-encoded patterns, the optical stylus comprising:
an image sensor for capturing at least one image of any position-encoded pattern of the position-encoded surface,
an object lens and an image lens arranged on both sides of a stop aperture,
a dynamic optical element mounted between the object lens and the image lens and configured to be electrically actuated in order to form onto the image sensor in-focus image of any position-encoded pattern of the position-encoded surface within a range of working distances along the optical axis of the stylus;
a distance measurement sensor, for example an optical Time-of-Flight sensor, for measuring said working distance,
a processing unit to control the dynamic optical element as a function of said working distance,
wherein the processing unit corrects in real time the signal acquired by the distance measurement sensor as a function of the tilt angle and the roll angle of the 3D pose of the optical stylus relative to the position-encoded surface to compute the working distance.

16. The method according to claim 15, wherein said tilt and roll angles are obtained by an Inertial Measurement Unit—IMU, from an algorithm based on the perspective distortion of the image of the position-encoded pattern as captured by the image sensor, or by using the data obtained by both the IMU and the algorithm.

17. The method according to claim 15, wherein said working distance is obtained by executing by the processing unit the following equation:
$$W D = ( {D}_{M} \cdot \frac{r}{\sqrt{{r}^{2} + {L}_{o}^{2}}} - r ) ( \frac{Lo}{r} + cos ψ \cdot tan φ )$$
wherein
D_{M} is the distance measured by the distance measurement sensor,
L_{O} is the distance between the distance measurement sensor and the outer surface of the object lens along the optical axis of the stylus,
r is the orthogonal distance between the optical axis of the stylus and the position of the distance measurement sensor,
φ and ψ are respectively the tilt and the roll angles of the optical stylus.

18. Method for controlling the voltage to be applied on a dynamic optical element of an optical stylus as a function of the 3D pose of the optical stylus relative to a position-encoded surface comprising different position-encoded patterns, the optical stylus comprising:
an image sensor for capturing at least one image of any position-encoded pattern of the position-encoded surface,
a dynamic optical element configured to be electrically actuated in order to form onto the image sensor in-focus images of any position-encoded pattern of the position-encoded surface within a range of working distances of the optical stylus,
a distance measurement sensor for measuring said working distances, and
a processing unit to control the dynamic optical element as a function of said working distances,
wherein the method comprises the steps of:
a. performing a measurement of said working distances with the distance measurement sensor;
b. determining the electrical voltage to be applied on the dynamic optical element by means of a distance-to-voltage conversion model using either:
an analytical model describing the relation between the voltage to be applied and measurement distance of said working distance, or
a look-up table storing the value of the voltage to be applied for any measurement of said working distance.

19. The method according to claim 18, wherein step a. is followed by the additional steps of:
c. obtaining at least one measurement performed by another sensor, such as the image sensor or an IMU sensor, including in the optical stylus, and
d. running on the processing unit a sensor fusion algorithm, such as a Kalman filter, to obtain a more precise measurement of said working distance as a function of the data obtained by the distance measurement sensor and said another sensor.

20. The method according to claim 18, comprising the additional steps of:
determining by an image analysis algorithm whether the quality of one or more images acquired by the image sensor is/are above a given threshold to ensure that the image of the position-encoded pattern is good enough to be used by the optical stylus, and
adapting the distance-to-voltage conversion model when the quality is below said given threshold to modify the focal length of the dynamic optical element so as to restore the quality of said one or more images above said given threshold.
